(19) United States
(12) Patent Application Publication
(10) Pub. No.: US 2011/0153363 A1
(43) Pub. Date: Jun. 23, 2011

(54) METHOD AND SYSTEM FOR MANAGING PERSONAL HEALTHCARE

(75) Inventors: Done Sik Yoo, Daejeon (KR); Tae Kon Kim, Seongnam (KR)

(73) Assignees: Electronics and Telecommunications Research Institute, Daejeon (KR); Korea University Industrial & Academic Collaboration Foundation, Seoul (KR)

(21) Appl. No.: 12/949,616

(22) Filed: Nov. 18, 2010

(30) Foreign Application Priority Data
Dec. 22, 2009 (KR) 10-2009-0128822
Jul. 6, 2010 (KR) 10-2010-0064885

(51) Int. Cl. G06Q 50/00; G06Q 10/00

(52) U.S. Cl. 705/3

(57) ABSTRACT

A method and system for managing personal health are provided. The system for managing personal healthcare includes: one or more agent devices measuring a plurality of types of physical information of a user; and a manager device receiving the plurality of types of physical information from the agent device, analyzing the correlations between the plurality of types of physical information, generating health management information indicating the correlations between the plurality of types of physical information, and providing the generated health management information to the user.

### CROSS-REFERENCE TO RELATED APPLICATIONS

This application claims the priority of Korean Patent Application No. 10-2009-0128822 filed on Dec. 22, 2009 and No. 10-2010-0064885 filed on Jul. 6, 2010, in the Korean Intellectual Property Office, the disclosure of which is incorporated herein by reference.

### BACKGROUND OF THE INVENTION

1. Field of the Invention

The present invention relates to a method and system for managing personal healthcare, and more particularly, to a method and system for managing personal healthcare capable of measuring a plurality of types of physical information relating to a user, processing correlations between the plurality of types of measured physical information into new information, and providing the corresponding information to the user, to thus allow the user to effectively manage his or her health or diseases.

2. Description of the Related Art

The worldwide aging of human beings and changes in modes of living have triggered the rapid growth of various diseases, including chronic diseases such as cancers, hypertension and diabetes, which are required to be continuously managed, and thus, people are becoming increasingly interested in monitoring their personal health.

Thus, recently, individuals have been making an effort to manage their health by directly measuring their weight, blood pressure, body temperature, blood sugar level, cholesterol level, and the like, and periodically checking their health by using personal health devices, such as a sphygmomanometer, scales, a pedometer, an oximeter, a thermometer, and the like.

Meanwhile, personal health devices, currently under development, generally include agent devices for measuring personal physical information and a manager device managing an overall communication network. The agent devices transmit measured personal physical information to the manager device at an appropriate time. However, both the agent devices and the manager device merely or simply measure, store, and transmit different types of physical information relating to an individual, having a limitation in collectively determining the physical condition of each individual. Namely, currently, various types of physical information measured by the different body sensors of individuals fall short of being effectively informatized to be utilized for managing personal health.

### SUMMARY OF THE INVENTION

An aspect of the present invention provides a method and system for managing personal healthcare capable of measuring a plurality of types of physical information of a user, processing the correlations between the plurality of types of measured physical information into new information, and providing the corresponding information to the user, to thus allow the user to effectively manage his health or diseases.

Another aspect of the present invention provides a method and system for managing personal healthcare capable of processing the correlations between a plurality of types of user history information including at least one of a plurality of types of physical information, past medication information, past disease information, and past physical information into new information, and providing the corresponding information to a user.

According to an aspect of the present invention, there is provided a system for managing personal healthcare, including: one or more agent devices measuring a plurality of types of physical information of a user; and a manager device receiving the plurality of types of physical information from the agent device, analyzing the correlations between the plurality of types of physical information, generating health management information indicating the correlations between the plurality of types of physical information, and providing the generated health management information to the user.

According to another aspect of the present invention, there is provided a method for measuring personal healthcare using a personal health management system that manages a user's health by exchanging information between an agent device and a manager device, including: measuring, by the agent device, a plurality of types of physical information of the user; analyzing, by the manager device, the correlations between the plurality of types of physical information and generating health management information indicating the correlations between the plurality of types of physical information; and providing, by the manager device, the health management information to the user.

The method may further include one of more of: providing, by the manager device, a feedback signal for measuring physical information of the user or adjusting a medication of the user to the agent device; transmitting, by the manager device, the health management information to an external server managed by a health management organization or a medical institution; and storing, by the manger device, the health management information in a database or a memory device.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a schematic configuration of a personal health management system according to an exemplary embodiment of the present invention;

FIG. 2 is a schematic block diagram showing an internal configuration of a manager device according to an exemplary embodiment of the present invention; and

FIG. 3 is a flow chart illustrating the process of a personal health management method according to an exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

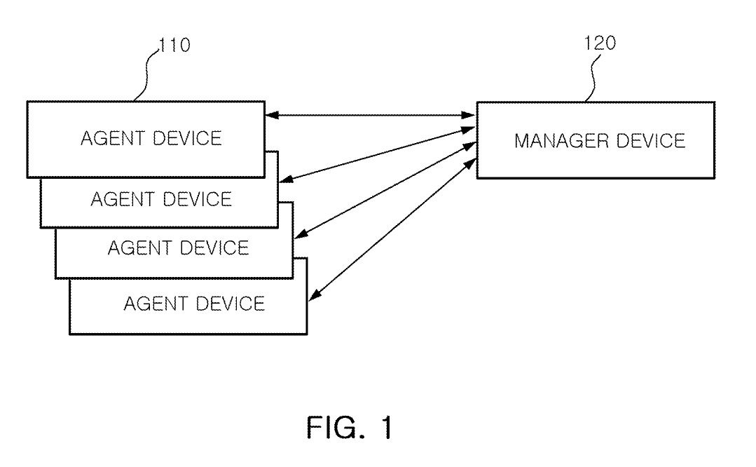

FIG. 1 illustrates a schematic configuration of a personal health management system according to an exemplary embodiment of the present invention.

With reference to FIG. 1, a personal health management system according to an exemplary embodiment of the present invention includes one or more agent devices 110 and a manager device 120.

The agent devices 110 measure a plurality of types of a user's physical information, and transmit the plurality of types of measured physical information to the manager device 120 through a wired or wireless communication network such as via Bluetooth™, ZigBee™, Wi-Fi, a USB (Universal Serial Bus), and the like. Here, the plurality of types of physical information may include weight, blood pressure, body temperature, blood sugar level, cholesterol level, body fat level, oxygen saturation, and the like.

The agent devices 110 may be a sphygmomanometer for measuring the user's blood pressure, scales for measuring the weight of the user, a pedometer for measuring the user's number of steps in walking, an oximeter for measuring oxygen concentration in the user's blood, a thermometer for measuring the user's body temperature, a fitness device, a drug therapy, and the like.

The manager device 120 receives the plurality of types of physical information from the agent devices 110, analyzes the correlation between the plurality of types of physical information as received, generates health management information indicating the correlation between the plurality of types of physical information, and provides the generated health management information to the user. Here, the manager device 120 may analyze the correlation between the plurality of types of physical information and user history information including at least one of the user's past medication information, past disease information, and past physical information, and generate health management information indicating the correlation between the plurality of types of physical information and the user history information.

In addition, the manager device 120 may recognize an agent device which can be periodically or intermittently used, enable the available agent device to measure a plurality of types of physical information at an appropriate time or adjust medication or the like, and receive the plurality of types of physical information from the available agent device, to thus feedback the user's health management. Namely, the manager device 120 may transmit a signal requesting the measurement of the plurality of types of physical information to the agent device 110, receive the plurality of types of measured physical information from the available agent device in response, analyze the correlation between the plurality of types of physical information as received, and newly generate health management information indicating the correlation between the plurality of types of physical information.

Also, the manager device 120 may transmit the generated health management information to an external server (not shown) managed by a health management organization, a medical institution, or the like, or store the generated health management information in a database, a USB memory device, or the like.

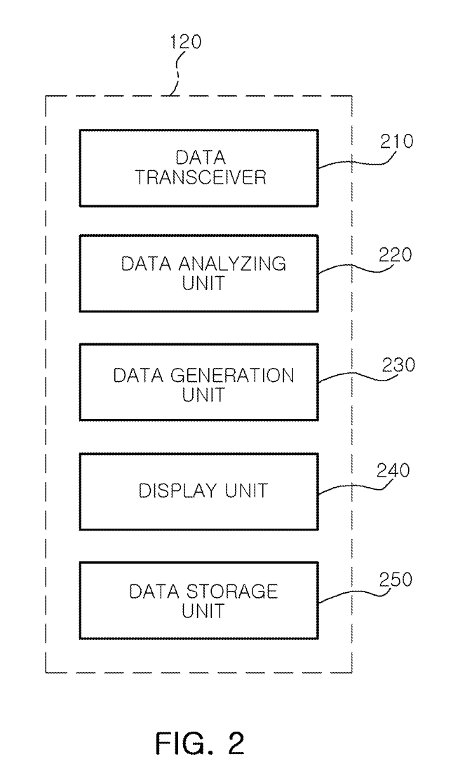

A detailed configuration of the manager device 120 according to an exemplary embodiment of the present invention will be described with reference to FIG. 2.

In addition, in the personal health management system according to an exemplary embodiment of the present invention, the agent devices 110 and the manager device 120 may be configured as a single device, and accordingly, the single device may measure a plurality of types of the user's physical information, analyze the correlation between the plurality of types of measured physical information, and generate health management information indicating the correlation between the plurality of types of physical information. In this case, the agent devices 110 and the manager device 120 may transmit and receive data through a data bus.

FIG. 2 is a schematic block diagram showing an internal configuration of the manager device according to an exemplary embodiment of the present invention.

With reference to FIG. 2, the manager device 120 includes a data transceiver 210, a data analyzing unit 220, a data generation unit 230 and a display unit 240.

The data transceiver 210 may receive a plurality of types of physical information from the agent devices 110, and transmit health management information corresponding to the plurality of types of physical information to an external server managed by a health management organization, a medical institution, or the like, or store it in a database, a USB memory device, or the like. In addition, the data transceiver 210 may transmit and receive a signal for feeding back the user's health management with the agent devices 110, for example, a feedback signal for measuring the user's physical information or adjusting the user's medication.

The data analyzing unit 220 analyzes the correlation between the plurality of types of physical information received from the agent device 110.

The data generation unit 230 generates the health management information indicating the correlation between the plurality of types of physical information.

The display unit 240 displays the health management information generated by the data generation unit 230 to a user's recognition.

The manager device 120 may further include a data storage unit 250 storing the user's medical history information including the user's past medication information, past disease information, and past physical information. Accordingly, the data analyzing unit 220 may analyze the correlation between the plurality of types of physical information and the user's medical history information, and generate health management information indicating the correlation between the plurality of types of physical information and the user's medical history information.

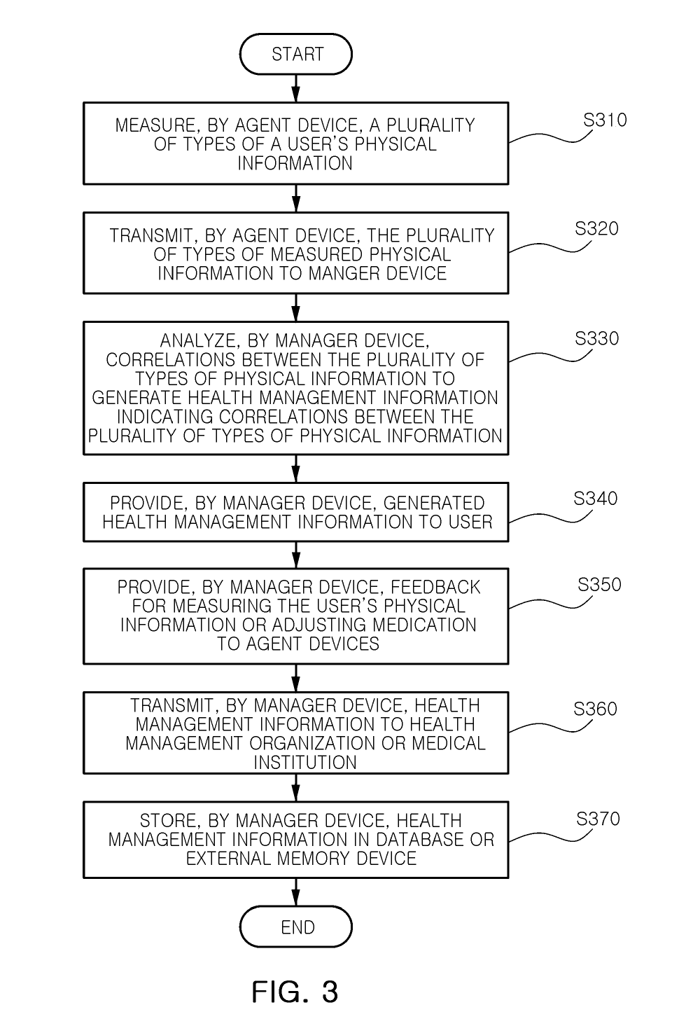

FIG. 3 is a flow chart illustrating the process of a personal health management method according to an exemplary embodiment of the present invention.

With reference to FIG. 3, the agent devices 110 measure a plurality of types of the user's physical information (step S310). Here, the agent devices 110 may be a sphygmomanometer for measuring the user's blood pressure, scales for measuring the weight of the user, a pedometer for measuring the user's number of steps in walking, an oximeter for measuring the oxygen concentration in the user's blood, a thermometer for measuring the user's body temperature, a fitness device, a drug therapy, and the like, and the plurality of types of physical information may include weight, blood pressure, body temperature, a blood sugar level, a cholesterol level, a body fat level, oxygen saturation, and the like.

The agent devices 110 transmit the plurality of types of measured physical information to the manager device 120 (step S320).

The manager device 120 analyzes the correlation between the plurality of types of received physical information and generates health management information indicating the correlation between the plurality of types of physical information (step S330). For example, the manager device 120 may provide health management information indicating that the user has lost weight and his blood sugar level has increased, so that he or she may discount or recognize the fact that he or she is a diabetic.

In step S330, the manager device 120 may analyze the correlation between the plurality of types of physical information and the user history information including at least one of the user's past medication information, past disease information, and past physical information, and generate health management information indicating the correlation between the plurality of types of physical information and the user history information. For example, in the case that the user has hypertension, the manager device 120 may provide health management information indicating a current blood pressure and a past blood pressure, medication information, and a change in weight, to allow the user to monitor how his or her hypertension symptoms have improved due to medication or weight control.

The manager device 120 provides the generated health management information to the user (step S340). In this case, the manager device 120 may display the generated health management information on the display unit for the user's recognition.

In addition, the manager device 120 may recognize an agent device which can be periodically or intermittently used, enable the available agent device to measure a plurality of types of physical information at an appropriate time or adjust medication or the like, and receive the plurality of types of physical information from the available agent device, to thus feedback the user's health management (step S350). Namely, the manager device 120 may transmit a signal requesting the measurement of the plurality of types of physical information to the agent device 110, receive the plurality of types of measured physical information from the available agent device in response, analyze the correlation between the plurality of types of physical information as received, and newly generate health management information indicating the correlation between the plurality of types of physical information. In this case, the operations of the agent devices are the same as those of steps S310 to S340, so a detailed description thereof will be omitted.

Also, the manager device 120 may transmit the generated health management information to an external server managed by health management organization, a medical institution, or the like (step S360), or store the generated health management information in a database, a USB memory device, or the like (step S370).

As set forth above, according to exemplary embodiments of the invention, the correlations between a plurality of types of an individual's physical information can be processed into information on the basis of the plurality of types of the individual's physical information, so as to be provided as collective or comprehensive information. Thus, health or a disease of an individual can be effectively managed and the utilization of a personal health device can be increased.

While the present invention has been shown and described in connection with the exemplary embodiments, it will be apparent to those skilled in the art that modifications and variations can be made without departing from the spirit and scope of the invention as defined by the appended claims.

What is claimed is:

1. A system for managing personal healthcare, the system comprising:
one or more agent devices measuring a plurality of types of physical information of a user; and
a manager device receiving the plurality of types of physical information from the agent device, analyzing the correlations between the plurality of types of physical information, generating health management information indicating the correlations between the plurality of types of physical information, and providing the generated health management information to the user.

2. The system of claim 1, wherein the manager device comprises:
a data analyzing unit analyzing the correlation between the plurality of types of physical information and user history information;
a data generation unit generating health management information indicating the correlation between the plurality of types of physical information and the user history information;
a display unit displaying the health management information to a user recognition; and
a data storage unit storing the user history information including at least one of a user's past medication information, past disease information, and past physical information.

3. The system of claim 1, wherein the manager device recognizes an available agent device, enables the available agent device to measure a plurality of types of physical information, and receives the plurality of types of physical information.

4. The system of claim 1, wherein the manager device provides a feedback signal for measuring the user's physical information or adjusting the user's medication to the one or more agent devices.

5. The system of claim 1, wherein the manager device transmits the generated health management information to an external server managed by a health management organization or a medical institution, or store the generated health management information in a database or a memory device.

6. The system of claim 1, wherein the agent device is connected to the manager device through a wired or wireless communication network to transmit the plurality of types of physical information to the manager device.

7. The system of claim 1, wherein the agent device is integrated with the manager device into a single device, is connected to the manager device through a data bus, and transmits the plurality of types of physical information to the manager device.

8. A method for measuring personal healthcare using a personal health management system that manages a user's health by exchanging information between an agent device and a manager device, the method comprising:
measuring, by the agent device, a plurality of types of physical information of the user;
analyzing, by the manager device, the correlations between the plurality of types of physical information and generating health management information indicating the correlations between the plurality of types of physical information; and
providing, by the manager device, the health management information to the user.

9. The method of claim 8, wherein, in generating the health management information, the manager device analyzes the correlation between the plurality of types of physical information and user history information including at least one of the user's past medication information, past disease information, and past physical information, and generates the health management information indicating the correlation between the plurality of types of physical information and the user history information.

10. The method of claim 8, further comprising:
recognizing, by the manager device, an available agent device;
enabling, by the manager device, an available agent device to measure a plurality of types of physical information; and
receiving, by the manager device, the plurality of types of physical information from the available agent device.

11. The method of claim 8, further comprising one or more of:
providing, by the manager device, a feedback signal for measuring physical information of the user or adjusting a medication of the user to the agent device;
transmitting, by the manager device, the health management information to an external server managed by a health management organization or a medical institution; and
storing, by the manger device, the health management information in a database or a memory device.
